(19) United States
(12) Patent Application Publication
(10) Pub. No.: US 2003/0150812 A1
(43) Pub. Date: Aug. 14, 2003

(54) Novel parallel throughput system

(76) Inventors: Irving Wainer, Washington, DC (US); Ruin Moaddel, Germantown, MD (US)

Correspondence Address: Supervisor, Patent Prosecution Services, PIPER RUDNICK LLP, 1200 Nineteenth Street, N.W., Washington, DC, 20036-2412, US

(21) Appl. No.: 10/322,714

(22) Filed: Dec. 19, 2002

Related U.S. Application Data
(60) Provisional application No. 60/340,836, filed on Dec. 19, 2001.

(51) Int. Cl. B01D 15/08

(52) U.S. Cl. 210/656; 210/198.2

(57) ABSTRACT

The present invention relates to a novel parallel throughput system that permits simultaneous screening of compounds in different modules of the system. Each module comprises a support having at least one species of protein binding moiety either immobilized through a covalent bond with the support surface to form an immobilized protein binding moiety or non-covalently immobilized in a stationary phase such that the tertiary structure of the protein in either immobilized binding moiety permits specific binding to a molecule that is bound by said protein in said immobilized binding moiety, and at least one marker molecule associated with the protein binding moiety species.

### BACKGROUND OF THE INVENTION

This application takes priority from Provisional Application No. 60/340,836, filed Dec. 19, 2001. The entirety of which, and all references cited herein, are incorporated by reference for all purposes.

### FIELD OF THE INVENTION

The present invention relates generally to a novel parallel throughput system. In particular, the present invention is a system that permits simultaneous screening of compounds.

The present invention relates generally to a device used in chromatography having a parallel throughput of distinct modules for determining compounds having a detectable binding affinity to one or more target binding moieties. The binding moieties in each module may be in a stationary phase or attached by covalent means to a support, or some combination of these embodiments in each. The binding moiety may be any protein, such as a receptor, an enzyme or a transport protein. Typical sources for the binding moiety in the invention include animal tissue, expressed cell lines or commercially synthesized proteins.

The device according to the invention can be employed in such diverse fields as organic synthesis, biochemistry and pharmacology, but has particular application in the field of drug discovery. The chromatography devices according to the invention can be used in displacement chromatography, frontal or zonal chromatography and other forms of chromatography to identify lead candidate molecules having a similar specific binding affinity as compared with one or more markers molecules. A marker molecule, by definition, has a known specific binding affinity for a distinct species of binding moiety in the chromatography device.

### DISCUSSION OF THE BACKGROUND

In drug development “Lead Optimization” is the process of going from an active compound to a new drug candidate for clinical testing. It involves the determination of how much of the compound will enter the body (adsorption {A}), where the compound will go once it is in the body (distribution {D}), what the body will do to the compound and the consequences of any metabolic transformations (metabolism {M}), how the body will get rid of the compound (excretion {E}), and the toxicological effect the drug will have as it enters and is metabolized in a subject (toxicology {T}). This process is identified as the ADMET stage of drug development.

New drug discovery programs often identify hundreds of compounds that have activity at a disease-related target. The ADMET stage is used to determine which compounds will have the best chance of becoming a drug. Poor performance in one or more of the ADMET studies will often eliminate the compound from the development program. The ADMET screen is done primarily for economic reasons as the next stages in the drug development program will involve in vivo animal studies, which consume a great deal of time and resources. Thus, the ADMET program is designed to identify a limited number of compounds for further testing and, thereby, optimize the chances of success.

Drugs active in the central nervous system (CNS) exert their pharmacologic activities by affecting a number of CNS receptors. These receptors include a variety of neurotransmitter receptors classified as the ligand gated ion channel (LGIC) receptor superfamily. When activated, LGIC receptors transmit a signal by altering the cell membrane potential or ionic composition. Ross, “Pharmacodynamics: Mechanisms of drug action and the relationship between drug concentration and effect,” Goodman and Gilman's The Pharmacological Basic of Therapeutics Ninth Edition, Hardman et al. (eds), McGraw Hill Publishers, New York, pp. 32-33 (1996).

The LGIC receptor superfamily is composed of three groups of receptors: the nicotinic, excitatory amino acid, and ATP purinergic receptors. In turn, the nicotinic receptor family is further subdivided into subfamilies of nicotinic (NCT), γ-aminobutyrate (GABA_{A}), glycine, and 5-hydroxytryptamine (serotonin) receptors. The same is true for the excitatory amino acid receptor family that is composed of glutamate, N-methyl D-aspartate (NMDA), AMPA, and kainate receptors. While the general biochemical mechanism is the same throughout the LGIC superfamily, there are dramatic differences in pharmacology, ion selectivity, and response to allosteric modulators between and within the families and subfamilies. Ross, “Pharmacodynamics: Mechanisms of drug action and the relationship between drug concentration and effect,” Goodman and Gilman's The Pharmacological Basic of Therapeutics Ninth Edition, Hardman et al. (eds), McGraw Hill Publishers, New York, pp. 32-33 (1996).

Numerous proteins including receptors, transporters and enzymes have been immobilized on a variety of stationary phases including immobilized artificial membranes (IAMs), silica and coordination complexes. The columns, depending on the protein, can last for about 5,000 column volumes, or for about two months of constant use. The columns typically can be stored for months at 4° C. and reused at a later date, having the same activity at reuse as they had prior to storage. Depending on the type of column, between 10⁶ and 10⁸ cells are used per column, or 6 to 8 grams of tissue.

The present inventors have successfully immobilized proteins on a glass surface in a single column utilizing a stationary phase or covalent attachment such as by using enzymes on an open tubular column. See Wainer et al., U.S. Pat. No. 6,139,735 and Attorney Docket No. 1908-013-27 filed Dec. 10, 2002 in the United States Patent and Trademark Office, both of which are incorporated by reference for all purposes.

### SUMMARY OF THE INVENTION

It is an object of the invention to provide a novel system that allows for the simultaneous screening of a compound or compounds through separate columns and/or modules. It is also an object of the present invention to provide a system for characterization of multiple members of a family of compounds.

Another object of the invention is to provide a parallel throughput system comprising at least one module, said module having a plurality of chromatography columns, wherein each column comprises a support having at least one species of protein binding moiety either (1) immobilized through a covalent bond with the support surface to form an immobilized protein binding moiety or (2) non-covalently immobilized in a stationary phase such that the tertiary structure of the protein in either type of immobilized protein binding moiety permits specific binding to a molecule that is bound by said protein in said immobilized binding moiety, and an injector for distributing a sample into the plurality of columns. Optionally, another object of the invention is to incorporate at least one marker molecule in at least one chromatography column according to the invention. Yet another object would be to incorporate a control column in the system of the invention. Yet still another object is to provide a parallel throughput system further comprising a pump or a detector for determining changes in the content of a mobile phase as it exits a column. Optionally, the detector relies upon indirect detection for determining changes in the content of a mobile phase as it exits a column, such as by utilizing fluorescent labels or ultraviolet light. Still, a further object of the invention is a parallel throughput system comprising a switching valve activated through the detector for directing the flow of the mobile phase from a column into a collector for detection by a secondary detector that is a mass spectrometer, a nuclear magnetic resonance machine, or an infrared spectrometer. Yet another object is parallel throughput system comprising a plurality of modules and a splitter for distributing sample to the plurality of modules.

### BRIEF DESCRIPTION OF THE DRAWINGS

FIG. 1 is a schematic illustration of the novel parallel throughput system of the present invention.

FIG. 2 is a graphical presentation of parallel throughput result with one column containing α4β2 nicotinic receptor and the other containing α4β4 nicotinic receptor using ultraviolet detection.

FIG. 3 is a graphical presentation of parallel throughput result with one column containing α3β2 nicotinic receptor and the other containing α3β4 nicotinic receptor using indirect detection with dinitrobenzoic acid.

### DETAILED DESCRIPTION OF THE INVENTION

Definitions

RECEPTOR—In general, a receptor is any protein (ie. membrane-bound or membrane enclosed molecule, water soluble or cytosolic) that binds to, or responds to something more mobile (i.e., the ligand), with some level of specificity. The level of specificity can be high, selective or low. Low specificity binding is often characterized as “dirty” or “promiscuous.” Examples include acetylcholine receptor, adenosine receptors, adrenergic receptors, adrenomedullin receptor, Ah receptor, amino acid receptors, AMPA (α-Amino-3-hydroxy-5-methyl-4-isoxazole propionic acid) receptor, ANP receptor, androgen receptor, baroreceptor, calcitonin gene related peptide receptor, cannabinoid receptors, chemokine receptors, chemoreceptor, Con A receptors, death receptors, EGF receptor, endothelin receptor, estrogen receptor, Fc receptors, fibroblast growth factor receptor, G-protein-coupled receptor, GABA (gamma aminobutyric acid) receptor, glutamate receptor, glycine receptor, growth factor receptor bound protein 2, glutamate receptor interacting protein, imidazoline receptors, IL-1 receptor associated kinase, insulin receptor substrate-1, immunoreceptor tyrosine-based activation motif, killer cell inhibitory receptor, killer cell immunoglobulin-like receptor, leptin receptor, low density lipoprotein receptor, muscarinic acetylcholine receptor, NCT receptors, α3/β4 NCT receptor-subtype, α4/β2 NCT receptor-subtype, nuclear receptor corepressor, nicotinic acetylcholine receptor, NMDA (N-methyl-D-Aspartate) receptor, nuclear receptor, opioid receptors, peptide neurotransmitter receptor, photoreceptors, peroxisome proliferator-activated receptors, presynaptic receptors, protease-activated receptors, purinergic receptors, receptors for activated C Kinase, receptor tyrosine kinases, scavenger receptors, serpentine receptors, signal recognition particle-receptor, steroid receptor, sulphonylurea receptors; T-cell receptor, TNF receptor, and vanilloid receptor-1, thyroid hormone receptors, retinoic acid receptor, progesterone receptor, glucocorticoid receptors, nuclear receptors and others including proteins that can also be classified channel proteins such as, ligand gated ion channels, voltage gated ion channels, potassium channel, calcium channel. This definition also includes orphan receptors.

ENZYME—An enzyme is any protein, natural or synthetic, that can catalyze one, and usually only one, specific biochemical reaction. Six functional types of enzymes are recognized which catalyze the following reactions: (1) redox (oxidoreductases), (2) transfer of specific radicals to groups (transferases), (3) hydrolysis (proteolytic), (4) removal from or addition to the substrate of specific chemical groups (lysases), (5) isomerization (isomerases), and (6) combination or binding together of substrate units (ligases). Specific examples include: abenzyme, angiotensin converting enzyme, apoenzyme, exoenzyme C3, catalytic antibody (i.e., abenzyme), coenzymes, coenzyme A, coenzyme M, coenzyme Q, ectoenzyme, endothelin converting enzyme, exoenzyme, holoenzyme, hydrolytic enzymes, interleukin-1 converting enzyme, isoenzymes, lysosomal enzymes, metalloenzyme, modification enzyme, N-acetylglucosaminyltransferase V, pro-enzyme, proteolytic enzyme, Q enzyme, restriction endonucleases or restriction enzymes, and coenzyme Q. This definition also includes orphan enzymes.

Most known enzymes are assigned an EC number by the Enzyme Commission and are listed in the ENZYME database at http://us.expasy.org/, the entire repository of which is incorporated by reference as of the filing date of this application. EC numbers are assigned primarily based on the recommendations of the Nomenclature Committee of the International Union of Biochemistry and Molecular Biology (IUBMB). The ENZYME database contains the physical and functional data and known characteristics for each type of characterized enzyme for which an EC (Enzyme Commission) number has been provided.

TRANSPORT PROTEIN—Transport proteins are any of the class of proteins involved in the transfer of a substance from one side of a plasma membrane to the other. The transport can be in a specific direction and can be at a rate faster than diffusion alone. Transport proteins that merely facilitate the diffusion of molecules or ions across a lipid membrane by forming a lipid pore are also called channel proteins. Also involved in transport are channel proteins. Specific examples of transport proteins include P-glycoprotein, and any of a class of protein that have been identified with active transport of a particular substance. These proteins include channel protein types such as A-channel, calcium channel, channel-forming ionophore, chloride channel, delayed rectifier channels, gated ion channel, G-protein-gated inward rectifying potassium channels, ion channel, L-type channels, ligand-gated ion channel, M-channels, N-type channels, P-type channels, potassium channel, Q-type channels, R-type channels, sodium channel, T-type channels, voltage-gated ion channel, and voltage-sensitive calcium channels. This definition also includes orphan transport proteins.

CYTOSOLIC PROTEIN—A protein, when fully developed in vivo, resides and functions in the cellular cytosol, or in the extracellular space.

MEMBRANE PROTEIN—A protein, when fully developed in vivo, has regions of the protein permanently attached to a membrane, or inserted into a membrane.

PERIPHERAL MEMBRANE PROTEIN—A protein, when fully developed in vivo, that is bound to the surface of the membrane and not integrated into the hydrophobic region.

TRANSMEMBRANE PROTEIN—A membrane protein having a protein subunit in which the polypeptide chain is exposed on both sides of the membrane, or having different subunits of a protein complex that are exposed at opposite surfaces of the membrane.

BINDING MOIETY—A peptide or nucleotide containing moiety having a known binding affinity for at least one marker molecule. The moiety can be a protein, a polypeptide, a protein fragment (such as an antibody fragment) or one or more subunit(s) of any protein. A typical example of a binding moiety would be an enzyme, a receptor or a transport protein. It can also be a carrier protein such as albumin or an antibody. The binding moiety can also be, or include, a sequence of DNA or RNA.

MARKER MOLECULE—Any compound having a known binding affinity for a binding moiety.

CONTROL COLUMN—a column for generating baseline chromatographical data from a compound having a known binding affinity for a protein binding moiety species, and the mobile phase has a known or expected effect on the binding affinity between the compound and the species of protein binding moiety.

While this invention is satisfied by embodiments in many different forms, there will herein be described in detail preferred embodiments of the invention, with the understanding that the present disclosure is to be considered as exemplary of the principles of the invention and is not intended to limit the invention to the embodiments illustrated and described. Numerous variations may be made by persons skilled in the art without departure from the spirit of the invention.

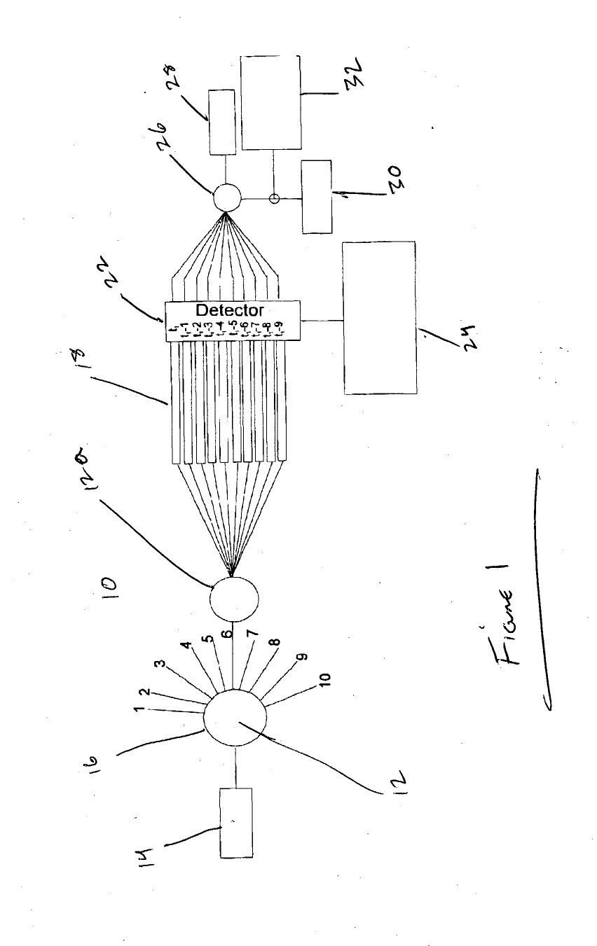

The novel parallel throughput system of the present invention will first be described by reference to FIG. 1, which is a schematic illustration of the parallel throughput system of the present invention. The system shown in FIG. 1 is generally represented by reference numeral 10. As shown in FIG. 1, system 10 comprises one or more modules 12a-j connected to a pump 14 via a splitter 16. The system may comprise up to ten or more modules, the number of which may be expanded according the specifications designated by the system designer. Details for only a single module (12a) are shown in FIG. 1. Each module comprises separate open tubular columns 18a-j. The columns may be, for example, capillary columns, or another type of chromatography column. Each module may preferably comprise ten columns, of which nine are experimental columns and one is a control column. The columns are connected by either a sequential or simultaneous injector 20. A detector 22 for simultaneously scanning of the columns is set up post-column. Detector 22 is connected to computer 24. The system further comprises a switching valve 26, waste container 28 and collector 30.

A second detector 32 may also be present between switch valve 26 and collector 30. The purpose of the second detector is structural identification of a compound under analysis. Accordingly, detector 32 may be any detector suitable for identifying the structure of an unknown compound. For example, detector 32 may be a mass spectrometer, a nuclear magnetic resonance machine, an infrared spectrometer, or the like. In one preferred embodiment, a mass spectrometer is used such as the Mass Spectrometer system (1997), ESI (Electrospray Source), G2170AA High Performance LC 2D Chemstation from Hewlett Packard.

In operation, a sample is injected into a pump and enters the splitter. The sample flows from the splitter, to the modules and then into, for example, a sequential injector. The sequential injector then injects the sample into the columns. There is a short (eg., one second) delay between injection onto each column. After injection onto the columns, the sample flows through the columns to the detector, which scans the columns. The initial detector preferably is used for indirect detection using fluorescent labels, i. e., detects displacement of fluorescent labels. The detector may also be used to detect ultraviolet light. At this point, data obtained by the detector is output from the detector to a computer. The computer compiles the data and may also transform the data into graphs, etc. In compiling the data, the computer adjusts or corrects for the one-second delay in each sequential column. From the detector, the flow continues on to the switching valve and can go either to a waste container or to a collector based on a predetermined cut-off time. Sample flowing off the columns prior to the predetermined cut-off time is sent to the waste container, while sample flowing off the columns after the predetermined cut-off time is collected. For example, the computer compares t₁ and tₓ, where x is 2-10. If tₓ is less than t₁, then the sample flow is sent to the waste container. If tₓ is greater than t₁, then the sample flow is sent to the collector.

If there is an unknown compound of interest, the switching valve can be turned such that the sample flows past a second detector. The second detector is then able to identify the unknown compound.

The time required from injection onto the system to collection varies. Assuming the time from injection to collection is about 20 seconds, up to 16,200 scans per hour can be run using a single parallel throughput system according to the present invention.

The parallel throughput system of the present invention can be used for a variety of purposes. Generally, the parallel throughput system can be used, for example, in drug discovery and bioanalytical chemistry. More specifically, the parallel throughput system may be used as a high throughput to screen for hits from a library of compounds. Another beneficial use of this system is to screen a family of proteins simultaneously. For example, the nicotinic receptor superfamily is a large family that contains a variety of neuronal nicotinic subtypes that are formed from the combination of a variety of α subunits (α2-α10) and β subunits (β1-β4). With the system of the present invention, the entire family of receptors, presuming the availability of the specific subtypes, can be screened simultaneously. This may be accomplished by immobilizing a single subtype of the protein on one column.

Having generally described this invention, a further understanding can be obtained by reference to certain specific examples which are provided herein for purposes of illustration only and are not intended to be limiting.

### EXAMPLES

A variety of subtypes of the nicotinic receptor including, but not limited to, α1β1δγ, α2β2, α2β2, α2β4, α3β2, α3β4, α4β2 α7, α8, and α9 would be immobilized onto the walls of open tubular capillaries or onto particulate matter packed into an equivalent-sized column (10 cm×150 μid). These columns will be placed on a single module of the parallel throughput system of the present invention. Separations on the various nicotinic receptor columns is achieved using a mobile phase consisting of ammonium acetate buffer (10 mM, pH 7.4)/methanol, 95/5 (v/v) at a flow rate of 0.1 ml/min. A 50 μl injection of a known or unknown ligand, for example 1 μM cytisine, onto the chromatographic system is performed. The time from injection to collection will be 1 min/column; therefore, the retention time of cytisine on nine subtypes of the nicotinic receptors could be determined in one minute. The retention times of cytisine on the numerous columns would be determined by indirect detection using 5 μM fluorescein as the dye in the mobile phase (λexc=488 nm; λemm=530 nm).

### Example 1

### Parallel Screen Using α4β2 Column and α4β4 Column

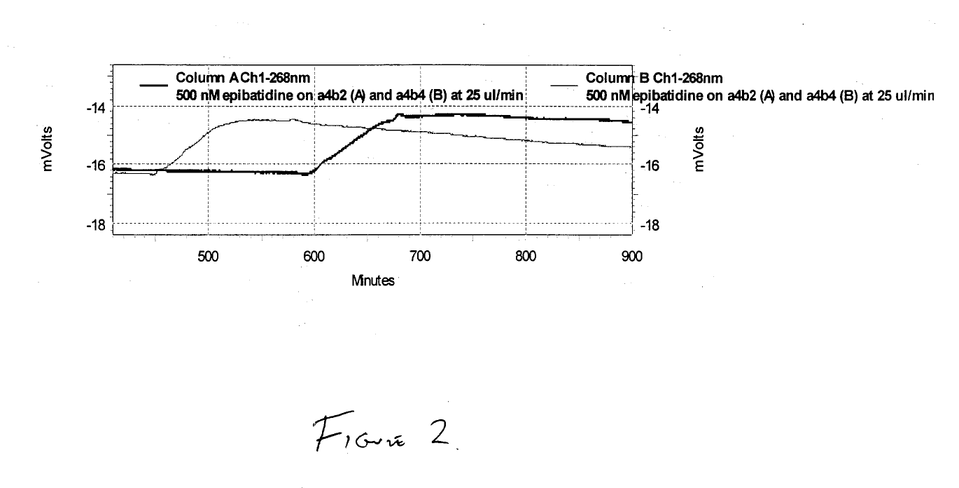

A parallel screen was run using two separate columns containing the different nicotinic receptors α4β2 and α4β4 in the separate columns. The columns were 24 cm in length, 0.03″ ID (772 μ) at a flow rate of 0.025 mL/min. with 0.5 μM epibatidine. Column A run at Ch1-268 nm. Column B run at Ch1-268 μnm. A graphical result of the result is displayed in FIG. 2.

### Example 2

### Parallel Screen Using α3β2 Column and α3β4 Column

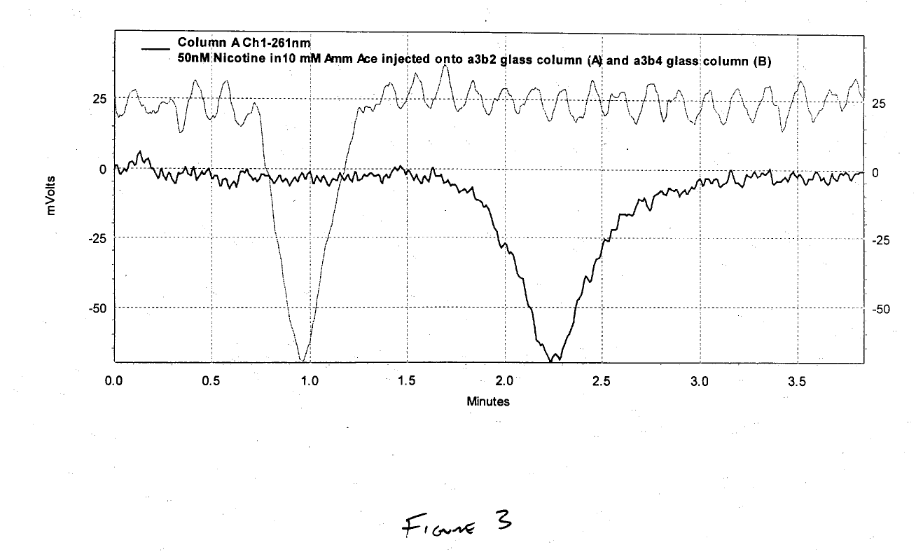

A parallel screen was run using two separate columns containing the different nicotinic receptors α3β2 and α4β4 in the separate columns. The parallel throughput demonstrates the result when indirect detection is utilized through using dinitrobenzoic acid with a 50 nM injection of nicotine. The mobile phase contained 10 mM Amm Acetate at pH 7.4 and 1 nM Dinitrobenzoic acid. The columns were 24 cm in length. Column A with α3β2 (EC50 of 7.7 μM) for 2.25 min. run at Ch1-261 nm. Column B with α3β4 (EC50 of 40.3 μM) for 0.98 min. run at Ch1-261 nm. A graphical representation of the result is displayed in FIG. 3.

The present invention having now been fully described with reference to representative embodiments and details, it will be apparent to one of ordinary skill in the art that changes and modifications can be made thereto without departing from the spirit or scope of the invention as set forth herein.

What is claimed:

1. A parallel throughput system comprising at least one module, said module comprising:
a) a plurality of chromatography columns, wherein each column comprises a support having at least one species of protein binding moiety either (1) immobilized through a covalent bond with the support surface to form an immobilized protein binding moiety or (2) noncovalently immobilized in a stationary phase such that the tertiary structure of the protein in either immobilized binding moiety permits specific binding to a molecule that is bound by said protein in said immobilized binding moiety, and
b) an injector for distributing a sample into the plurality of columns.

2. The parallel throughput system according to claim 1, further comprising at least one marker molecule in at least one chromatography column.

3. The parallel throughput system according to claim 1, wherein one column of said plurality is a control column.

4. The parallel throughput system according to claim 1, wherein said system further comprises a pump.

5. The parallel throughput system according to claim 1, wherein said system further comprises a detector for determining changes in the content of a mobile phase as it exits a column.

6. The parallel throughput system according to claim 5, wherein the detector relies upon indirect detection for determining changes in the content of a mobile phase as it exits a column.

7. The parallel throughput system according to claim 6, wherein the detector uses fluorescent labels or ultraviolet light.

8. The parallel throughput system according to claim 6, wherein the detector uses fluorescent labels and detects displacement of fluorescent labels.

9. The parallel throughput system according to claim 5, wherein said system further comprises a switching valve activated through the detector for directing the flow of the mobile phase from a column into a collector.

10. The parallel throughput system according to claim 9, wherein said system further comprises a secondary detector for analyzing the contents of the collector.

11. The parallel throughput system according to claim 9, wherein said secondary detector is a mass spectrometer, a nuclear magnetic resonance machine, or an infrared spectrometer.

12. The parallel throughput system according to claim 9, wherein said secondary detector is a mass spectrometer.

13. The parallel throughput system according to claim 1, wherein said system comprises a plurality of modules.

14. The parallel throughput system according to claim 13, wherein said system comprises a splitter for distributing sample to the plurality of modules.

15. The parallel throughput system according to claim 1, wherein said columns are capillary columns.

16. A method of using parallel throughput system having at least one module, said module comprising a plurality of chromatography columns, wherein each column comprises a support having at least one species of protein binding moiety either (1) immobilized through a covalent bond with the support surface to form an immobilized protein binding moiety or (2) non-covalently immobilized in a stationary phase such that the tertiary structure of the protein in either immobilized binding moiety permits specific binding to a molecule that is bound by said protein in said immobilized binding moiety, and an injector for distributing a sample into the plurality of columns, said method comprising:
a) placing a sample into said module; and
b) injecting said sample into said plurality of columns.

17. The method according to claim 16, further comprising:
c) detecting for any changes in a mobile phase as it exits the plurality columns.

18. The method according to claim 17, further comprising:
c) collecting a sample in which has been detected a change in the mobile phase as it exits the plurality columns.

19. The method according to claim 18, further comprising:
d) performing a secondary detection to determine the structure of a compound in the collected sample.

20. A method for performing drug discovery utilizing a parallel throughput system having at least one module, said module comprising a plurality of chromatography columns, wherein each column comprises a support having at least one species of protein binding moiety either (1) immobilized through a covalent bond with the support surface to form an immobilized protein binding moiety or (2) non-covalently immobilized in a stationary phase such that the tertiary structure of the protein in either immobilized binding moiety permits specific binding to a molecule that is bound by said protein in said immobilized binding moiety, and an injector for distributing a sample into the plurality of columns, said method comprising:
a) analyzing a sample with said system in a process of lead optimization.

21. The method according to claim 20, wherein the lead optimization process involves gathering data toward analyzing the adsorption, distribution, metabolism, excretion, or the toxicological effect of a molecule.
